(19) United States
(12) Patent Application Publication
(10) Pub. No.: US 2024/0202670 A1
(43) Pub. Date: Jun. 20, 2024

(54) AUTOMATED FLEET ASSET HEALTH MONITORING AND MAINTENANCE SCHEDULING

(71) Applicant: International Business Machines Corporation, Armonk, NY (US)

(72) Inventors: Dzung Tien Phan, Pleasantville, NY (US); Nianjun Zhou, Chappaqua, NY (US); Pavankumar Murali, Ardsley, NY (US)

(73) Assignee: International Business Machines Corporation, Armonk, NY (US)

(21) Appl. No.: 18/081,342

(22) Filed: Dec. 14, 2022

(51) Int. Cl. G06Q 10/20; G06Q 10/0631

(52) U.S. Cl. CPC G06Q 10/20; G06Q 10/063116; G06Q 10/04

(57) ABSTRACT

A graph representing a current state of a set of assets is constructed, a weighted node in the graph representing an asset in the set of assets, a weighted edge in the graph representing a connection between two assets in the set of assets, a weight of the weighted node determined using an asset health score of the asset, a weight of the weighted edge determined according to an importance of the connection. A divergence between the graph and a previous graph representing a previous state of the set of assets is scored, the scoring resulting in a divergence score. Responsive to the divergence score being above a threshold score, a current maintenance schedule of the set of assets is adjusted, the adjusting resulting in an adjusted maintenance schedule.

### BACKGROUND

The present invention relates generally to a method, system, and computer program product for automated asset management. More particularly, the present invention relates to a method, system, and computer program product for automated fleet asset health monitoring and maintenance scheduling.

A fleet is a set of assets that are managed as a group. For example, a fleet might include all of the electrical distribution equipment of a utility company, from the components in a power generating station through high-capacity transmission lines and transformers to individual consumers' homes and businesses. As another example, a fleet might include a city's traffic management infrastructure, including roads, sidewalks, bridges, traffic lights, stop signs, and the like. As a third example, a fleet might include all of an airline's equipment, including airplanes, baggage carts, food delivery vehicles, fuel trucks, and the like.

Individual assets within a fleet are managed and maintained using a maintenance schedule, based on predictions of asset health. For example, roads require repaving every few years, gas-powered vehicles require periodic oil changes, and airplanes require periodic inspections and part replacements. For each task in a maintenance schedule, the item to be maintained, workers skilled in performing the task, and tools and materials necessary for the task must all be coordinated so as to be present in the same place at the same time.

Tasks in a maintenance schedule are often scheduled to improve efficiency of maintaining the fleet as a whole. Tasks are often grouped based on geographical information, impact on users of the fleet, availability of specialized equipment or workers, and the like. For example, it is more efficient for a traffic light maintenance crew to maintain all the traffic lights at one intersection, then all the traffic lights at another intersection a block away, all in the same day, than to spend one work day maintaining one traffic light at the first intersection and one traffic light elsewhere in a city, and return a week later to maintain the rest of the traffic lights at the first intersection. As another example, a city's fleet of snow plows might be maintained during the summer or fall, when the plows are unlikely to be needed, so as to be ready for use when snowstorms are more likely to occur.

### SUMMARY

The illustrative embodiments provide a method, system, and computer program product. An embodiment includes a method that constructs a graph representing a current state of a set of assets, a weighted node in the graph representing an asset in the set of assets, a weighted edge in the graph representing a connection between two assets in the set of assets, a weight of the weighted node determined using an asset health score of the asset, a weight of the weighted edge determined according to an importance of the connection. An embodiment scores a divergence between the graph and a previous graph representing a previous state of the set of assets, the scoring resulting in a divergence score. An embodiment adjusts, responsive to the divergence score being above a threshold score, a current maintenance schedule of the set of assets, the adjusting resulting in an adjusted maintenance schedule.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for automated fleet asset health monitoring and maintenance scheduling in accordance with an illustrative embodiment;

FIG. 3 depicts a block diagram of an example configuration for automated fleet asset health monitoring and maintenance scheduling in accordance with an illustrative embodiment;

FIG. 4 depicts an example of automated fleet asset health monitoring and maintenance scheduling in accordance with an illustrative embodiment;

FIG. 5 depicts an example of graph divergence scoring for use in automated fleet asset health monitoring and maintenance scheduling in accordance with an illustrative embodiment;

FIG. 6A depicts an optimization problem for use in automated fleet asset health monitoring and maintenance scheduling in accordance with an illustrative embodiment;

FIG. 6B depicts a continuation of an optimization problem for use in automated fleet asset health monitoring and maintenance scheduling in accordance with an illustrative embodiment;

FIG. 7 depicts a flowchart of an example process for automated fleet asset health monitoring and maintenance scheduling in accordance with an illustrative embodiment.

### DETAILED DESCRIPTION

The illustrative embodiments recognize that, because a maintenance schedule is based on predictions of asset health, the schedule may need updating if the predictions, or asset health and other data on which the predictions were made, change. For example, a hard drive scheduled for replacement next year might be reporting an increasing number of write errors, indicating that the drive is likely to fail altogether within the next week. Thus, the drive should be replaced earlier than originally scheduled. As another example, an exceptionally harsh winter might have caused more potholes in a city's roads than predicted, requiring more road repair and repaving than originally scheduled. However, the illustrative embodiments also recognize that, because tasks in a maintenance schedule are often scheduled to improve efficiency of maintaining the fleet as a whole, updating the schedule to account for a change in one asset can have unanticipated effects on other portions of the schedule. In addition, frequent maintenance schedule updates can be disruptive to material delivery schedules, worker schedules, and the like. Thus, the illustrative embodiments recognize that there is a need to trade off reacting to changes in asset health predictions by updating a maintenance schedule only as often as necessary, considering the entire fleet to which the asset belongs.

The illustrative embodiments recognize that the presently available tools or solutions do not address these needs or provide adequate solutions for these needs. The illustrative embodiments used to describe the invention generally address and solve the above-described problems and other problems related to automated fleet asset health monitoring and maintenance scheduling.

An embodiment can be implemented as a software application. The application implementing an embodiment can be configured as a modification of an existing asset health monitoring and maintenance scheduling system, as a separate application that operates in conjunction with an existing asset health monitoring and maintenance scheduling system, a standalone application, or some combination thereof.

Particularly, some illustrative embodiments provide a method that constructs a graph representing a current state of a set of assets, scores a divergence between the graph and a previous graph representing a previous state of the set of assets, and adjusts, responsive to the divergence score being above a threshold score, a current maintenance schedule of the set of assets.

An embodiment receives asset configuration data, which is data of the individual asset configurations and relationships between assets in a set of assets being managed as a fleet. An embodiment also receives asset condition data, which is data of individual assets' conditions. Some assets include sensors that report condition data of an asset—for example, the current rate of write errors in a hard drive. Asset condition data for other assets might be obtained via a report of a visual inspection (e.g., the number of potholes observed per mile of a particular road, the appearance of oil removed from an engine during an oil change, or the amount of tread remaining in a tire), a prediction (e.g., a part on an airplane engine should be replaced every 400 hours of flight, and a particular engine has operated for 200 hours since the last replacement), or another presently available technique. An embodiment also receives an existing maintenance schedule for the fleet of assets, if the embodiment did not generate the existing maintenance schedule.

An embodiment constructs a graph representing a current state of a set of assets being managed as a fleet. Each node of the graph represents an asset, or a group of assets being managed as a single asset. For example, an airplane might include two engines, as well as numerous other parts. In some asset management implementations, the engines and other parts might be managed as a single asset, the airplane, while in other implementations it might be desirable to manage each engine as a separate asset. Each edge of the graph, connecting two nodes, represents a connection, or relationship, between two assets, each represented by one of the nodes. For example, in a graph representing all of the electrical distribution equipment of a utility company, nodes might represent assets such as power generating stations and transformers, while edges might represent connections such as transmission lines.

Both nodes and edges of the graph are weighted. An embodiment sets weights of nodes in the graph using an asset health score of an asset corresponding to a node. One embodiment calculates the weight of a node by multiplying an asset health score of an asset corresponding to the node by a criticality score of the asset. A criticality score of an asset is a measure of how critical the asset is to the functionality of the fleet. For example, for a utility company, a power generation station serving a large area might have the maximum criticality score, while a transformer serving a few houses might have the minimum criticality score. Techniques are presently available to assign criticality scores, such as using a set of rules or heuristics, asking a human expert, and the like. An asset health score of an asset is a measure of asset's health. An embodiment determines an asset health score by evaluating, using an analysis of available asset condition data, the asset's health condition. One embodiment uses a set of rules to determine an asset health score. For example, a hard drive might have two possible numerical scores, one denoting that the hard drive is healthy and the other denoting that the hard drive is not healthy, depending on whether the current rate of write errors is below or above a threshold value.

As another example, a road might have five possible numerical scores, each corresponding to a range in the number of potholes observed per mile. Another embodiment uses an asset's own reporting of its health as the asset health score, normalized if necessary to allow for comparison with the scores of other assets. Another embodiment scores an asset's health condition according to a function corresponding to a current status of the asset with respect to a periodic maintenance schedule. For example, if a part on an airplane engine should be replaced every 400 hours of flight, the asset health score for the engine might decrease linearly from maximum (just after part replacement) to minimum (when the part requires replacement now) every 400 hours, or the asset health score for the engine might be constant for most of the 400 hours but decay exponentially in the last 20 hours before the replacement. Other techniques for scoring an asset's health condition are also possible and contemplated within the scope of the illustrative embodiments.

An embodiment determines a weight of an edge according to an importance of the connection between the two represented assets. Techniques are presently available to assign weight of an edge according to an importance of the connection between the two represented assets, such as using a set of rules or heuristics, asking a human expert, and the like. For example, the weight of an edge might be proportional to the voltage or current flowing between particular assets of a utility company, or the average amount of traffic between two road intersections, assets of a city's infrastructure. As another example, weights of edges between nodes representing particular types of assets might be set to one value, while weights of edges between nodes representing other types of assets might be set to another value, according to a set of weighting rules based on node types.

An embodiment scores a divergence between the graph (denoted by q) and a previous graph representing a previous state of the set of assets, resulting in a divergence score. In particular, an embodiment represents the graph as an inverse covariance matrix of a multivariate Gaussian distribution (denoted by Σ_{q}⁻¹). Weights of the graph nodes are the diagonal entries in the matrix, and weights of the graph edges are the non-diagonal entries in the matrix. An embodiment also represents a previous version of the graph (denoted by p) representing a previous state of the set of assets as an inverse covariance matrix of a multivariate Gaussian distribution (denoted by Σₚ⁻¹), in which weights of nodes in the previous version of the graph are the diagonal entries in the matrix, and weights of edges in the previous version of the graph are the non-diagonal entries in the matrix. An embodiment computes a Kullback-Leibler (K-L) divergence, a type of presently available statistical distance measurement technique measuring how one probability distribution P is different from a second, reference probability distribution Q, on the two matrices Σ_{q}⁻¹ and Σₚ⁻¹. In particular, because the two probability distributions are normalized, their means are 0, and the K-L divergence from P to Q, D_{KL(p∥q)} is equal to one-half the matrix defined by log (det(Σ_{q})/det(Σₚ))−k+tr{Σ_{q}⁻¹Σₚ}, where k denotes the number of nodes in each graph (the number of nodes is the same in each graph), det(A) denotes the determinant of the matrix A, and the tr{ } operation sums the diagonals of the elements in a matrix. Because the K-L divergence from distribution P to distribution Q can be different from the K-L divergence from distribution Q to distribution P, an embodiment computes both D_{KL(p∥q)} and D_{KL(q∥p)} and uses their average as the divergence score between the two graphs p and q.

If the divergence score is less than or equal to a threshold value, the graph (representing the current state of the fleet's health using the inverse covariance matrix Σ_{q}⁻¹) has not changed sufficiently from the previous version of the graph (representing a previous state of the fleet's health via Σₚ⁻¹ used to formulate the current maintenance schedule), and thus there is no need to update the current maintenance schedule. On the other hand, if the divergence score is greater than the threshold value, the fleet's health has changed sufficiently that the current maintenance schedule should be updated.

Another embodiment does not compute a K-L divergence between graph versions, but instead computes the difference between two graphs E=abs(Σₚ⁻¹−E_{q}⁻¹), where abs(A) denotes the absolute value A. The difference graph is G=(V, E), where the set of vertices V is the same with the set of vertices in p and q. Weights of the graph nodes in G are the diagonal entries in the E matrix. Weights of edges in the graph G are the non-diagonal entries in the E matrix. An embodiment identifies a subgraph with the most changes by maximizing the average weight Z_{i,j∈S}Eᵢⱼ/|S| in a densest subgraph S, where |S| is the number of nodes in S. An embodiment identifies a subgraph with the least changes by minimizing the average weight Z_{i,j∈U}Eᵢⱼ/|U| in a densest subgraph U. Other techniques to identify subgraphs with maximal and minimal changes and to use the identified subgraphs as candidates for rescheduling are also presently available.

To update the current maintenance schedule of the set of assets, an embodiment represents the maintenance schedule as a linear optimization problem, and solves the problem. In particular, an embodiment defines the target of the optimization problem as maximizing a system reliability term, thus improving a risk of the set of assets, while minimizing a term representing deviation from the current maintenance schedule. An embodiment defines a set of constraints on the optimization problem. The optimization can be solved using Mixed-Integer Linear Programming (MILP), a presently available technique for solving problems with a linear objective function, no non-linear constraints, and at least some of the unknown values are integers. Other techniques for solving linear optimization problems are also presently available. An embodiment uses the resulting problem solution to update, or adjust, the current maintenance schedule.

An embodiment causes performance of the adjusted maintenance schedule, resulting in an alteration in an asset health score of an asset in the set of assets. For example, the adjusted maintenance schedule might specify that a particular portion of road be repaved on a particular date, by a particular crew, using a specified list of equipment and materials. Repaving the road improves its health score as well.

An embodiment periodically repeats the entire process, as events may have occurred that alter asset (and thus, fleet) health status and the need for maintenance. For example, a series of winter storms may have increased the number of potholes in a road, necessitating earlier-than-originally-scheduled repaving, or a higher-than-expected electrical demand may have shortened the expected life of some electrical generation components. For example, an embodiment might repeat the process once per quarter, or once per year.

The manner of automated fleet asset health monitoring and maintenance scheduling described herein is unavailable in the presently available methods in the technological field of endeavor pertaining to automated asset management. A method of an embodiment described herein, when implemented to execute on a device or data processing system, comprises substantial advancement of the functionality of that device or data processing system in constructing a graph representing a current state of a set of assets, scoring a divergence between the graph and a previous graph representing a previous state of the set of assets, and adjusting, responsive to the divergence score being above a threshold score, a current maintenance schedule of the set of assets.

The illustrative embodiments are described with respect to certain types of assets, graphs, nodes, edges, weights, scores, forecasts, thresholds, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

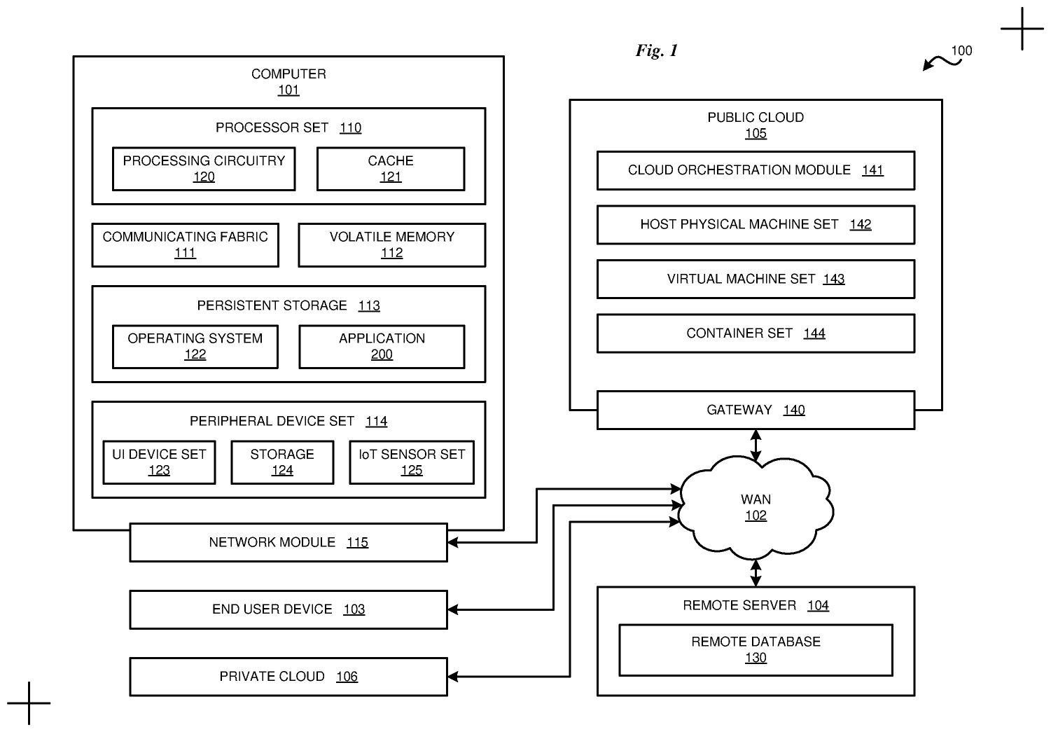

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements an automated fleet asset health monitoring and maintenance scheduling embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. In addition, application 200 may receive asset monitoring data from IoT sensor set 125, or from another source.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

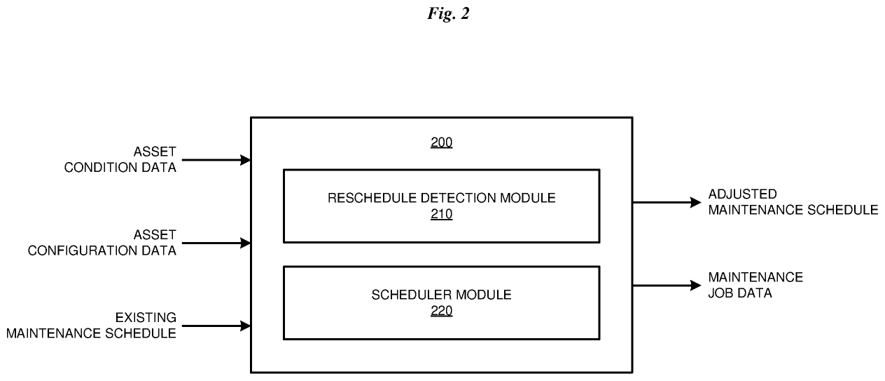

With reference to FIG. 2, this figure depicts a block diagram of an example configuration for automated fleet asset health monitoring and maintenance scheduling in accordance with an illustrative embodiment. Application 200 is the same as application 200 in FIG. 1.

Application 200 receives asset configuration data, which is data of the individual asset configurations and relationships between assets in a set of assets being managed as a fleet. Application 200 also receives asset condition data, which is data of individual assets' conditions. Some assets include sensors that report condition data of an asset—for example, the current rate of write errors in a hard drive. Asset condition data for other assets might be obtained via a report of a visual inspection (e.g., the number of potholes observed per mile of a particular road, the appearance of oil removed from an engine during an oil change, or the amount of tread remaining in a tire), a prediction (e.g., a part on an airplane engine should be replaced every 400 hours of flight, and a particular engine has operated for 200 hours since the last replacement), or another presently available technique. Application 200 also optionally receives an existing maintenance schedule for the fleet of assets.

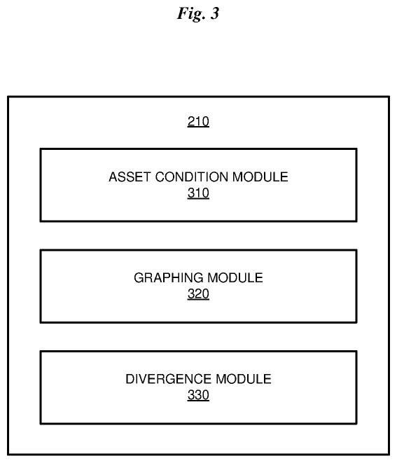

Reschedule detection module 210 determines whether existing maintenance schedule for the fleet of assets needs adjustment. More detail of module 210 is presented with respect to FIG. 3.

If the divergence score is less than or equal to a threshold value, the graph (representing the current state of the fleet's health using the inverse covariance matrix Σ_{q}⁻¹) has not changed sufficiently from the previous version of the graph (representing a previous state of the fleet's health via Σₚ⁻¹ used to formulate the current maintenance schedule), and thus there is no need to update the current maintenance schedule. On the other hand, if the divergence score is greater than the threshold value, the fleet's health has changed sufficiently that the current maintenance schedule should be updated. To update the current maintenance schedule of the set of assets, scheduler module 220 represents the maintenance schedule as a linear optimization problem, and solves the problem. In particular, module 220 defines the target of the optimization problem as maximizing a system reliability term, thus improving a risk of the set of assets, while minimizing a term representing deviation from the current maintenance schedule. Scheduler module 220 defines a set of constraints on the optimization problem. The optimization can be solved using MILP or another presently available technique. Scheduler module 220 uses the resulting problem solution to update, or adjust, the current maintenance schedule.

Application 200 causes performance of the adjusted maintenance schedule, resulting in an alteration in an asset health score of an asset in the set of assets. For example, the adjusted maintenance schedule might specify that a particular portion of road be repaved on a particular date, by a particular crew, using a specified list of equipment and materials. Repaving the road improves its health score as well.

With reference to FIG. 3, this figure depicts a block diagram of an example configuration for automated fleet asset health monitoring and maintenance scheduling in accordance with an illustrative embodiment. In particular, FIG. 3 provides more detail of reschedule detection module 210 in FIG. 2.

Graphing module 320 constructs a graph representing a current state of a set of assets being managed as a fleet. Each node of the graph represents an asset, or a group of assets being managed as a single asset. For example, an airplane might include two engines, as well as numerous other parts. In some asset management implementations, the engines and other parts might be managed as a single asset, the airplane, while in other implementations it might be desirable to manage each engine as a separate asset. Each edge of the graph, connecting two nodes, represents a connection, or relationship, between two assets, each represented by one of the nodes. For example, in a graph representing all of the electrical distribution equipment of a utility company, nodes might represent assets such as power generating stations and transformers, while edges might represent connections such as transmission lines.

Both nodes and edges of the graph are weighted. Module 320 sets weights of nodes in the graph using an asset health score of an asset corresponding to a node. One implementation of module 320 calculates the weight of a node by multiplying an asset health score of an asset corresponding to the node by a criticality score of the asset. A criticality score of an asset is a measure of how critical the asset is to the functionality of the fleet. For example, for a utility company, a power generation station serving a large area might have the maximum criticality score, while a transformer serving a few houses might have the minimum criticality score. Techniques are presently available to assign criticality scores, such as using a set of rules or heuristics, asking a human expert, and the like. An asset health score of an asset is a measure of asset's health. Asset condition module 310 determines an asset health score by evaluating, using an analysis of available asset condition data, the asset's health condition. One implementation of module 310 uses a set of rules to determine an asset health score. For example, a hard drive might have two possible numerical scores, one denoting that the hard drive is healthy and the other denoting that the hard drive is not healthy, depending on whether the current rate of write errors is below or above a threshold value. As another example, a road might have five possible numerical scores, each corresponding to a range in the number of potholes observed per mile. Another implementation of module 310 uses an asset's own reporting of its health as the asset health score, normalized if necessary to allow for comparison with the scores of other assets. Another implementation of module 310 scores an asset's health condition according to a function corresponding to a current status of the asset with respect to a periodic maintenance schedule. For example, if a part on an airplane engine should be replaced every 400 hours of flight, the asset health score for the engine might decrease linearly from maximum (just after part replacement) to minimum (when the part requires replacement now) every 400 hours, or the asset health score for the engine might be constant for most of the 400 hours but decay exponentially in the last 20 hours before the replacement.

Module 320 determines a weight of an edge according to an importance of the connection between the two represented assets. Techniques are presently available to assign weight of an edge according to an importance of the connection between the two represented assets, such as using a set of rules or heuristics, asking a human expert, and the like. For example, the weight of an edge might be proportional to the voltage or current flowing between particular assets of a utility company, or the average amount of traffic between two road intersections, assets of a city's infrastructure. As another example, weights of edges between nodes representing particular types of assets might be set to one value, while weights of edges between nodes representing other types of assets might be set to another value, according to a set of weighting rules based on node types.

Divergence module 330 scores a divergence between the graph (denoted by q) and a previous graph representing a previous state of the set of assets, resulting in a divergence score. In particular, module 330 represents the graph as an inverse covariance matrix of a multivariate Gaussian distribution (denoted by Σ_{q}⁻¹). Weights of the graph nodes are the diagonal entries in the matrix, and weights of the graph edges are the non-diagonal entries in the matrix. Module 330 also represents a previous version of the graph (denoted by p) representing a previous state of the set of assets as an inverse covariance matrix of a multivariate Gaussian distribution (denoted by Σₚ⁻¹), in which weights of nodes in the previous version of the graph are the diagonal entries in the matrix, and weights of edges in the previous version of the graph are the non-diagonal entries in the matrix. Module 330 computes a K-L divergence on the two matrices Σ_{q}⁻¹ and Σₚ⁻¹. In particular, because the two probability distributions are normalized, their means are 0, and the K-L divergence from P to Q, D_{KL(p∥q)} is equal to one-half the matrix defined by log (det(Σ_{q})/det(Σₚ))−k+tr {Σ_{q}⁻¹Σₚ}, where k denotes the number of nodes in the graph, det(A) denotes the determinant of the matrix A, and the tr{ } operation sums the diagonals of the elements in a matrix. Because the K-L divergence from distribution P to distribution Q can be different from the K-L divergence from distribution Q to distribution P, an embodiment computes both D_{KL(p∥q)} and D_{KL(q∥p)} and uses their average as the divergence score between the two graphs p and q.

Another implementation of module 330 does not compute a K-L divergence between graph versions, but instead computes the difference between two graphs E=abs(Σₚ⁻¹−Σ_{q}¹), where abs(A) denotes the absolute value A. The difference graph is G=(V, E), where the set of vertices V is the same with the set of vertices in p and q. Weights of the graph nodes in G are the diagonal entries in the E matrix. Weights of edges in the graph G are the non-diagonal entries in the E matrix. An embodiment identifies a subgraph with the most changes by maximizing the average weight E_{i,j∈S}Eᵢⱼ/|S| in a densest subgraph S, where |S| is the number of nodes in S. An embodiment identifies a subgraph with the least changes by minimizing the average weight E_{i,j∈U}Eᵢⱼ/|U| in a densest subgraph U.

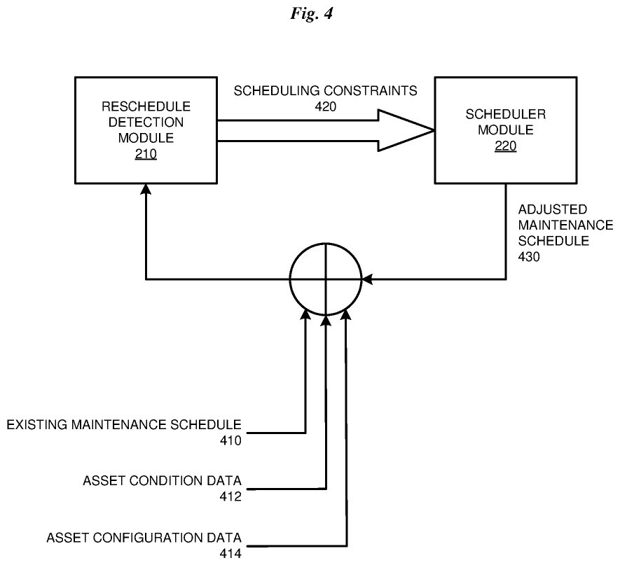

With reference to FIG. 4, this figure depicts an example of automated fleet asset health monitoring and maintenance scheduling in accordance with an illustrative embodiment. The example can be executed using application 200 in FIG. 2. Reschedule detection module 210 and scheduler module 220 are the same as reschedule detection module 210 and scheduler module 220 in FIG. 2.

As depicted, reschedule detection module 210 receives existing maintenance schedule 410, asset condition data 412, and asset configuration data 414, analyzes them in manner described herein, and produces scheduling constraints 420, which scheduler module 220 uses to produce adjusted maintenance schedule 430.

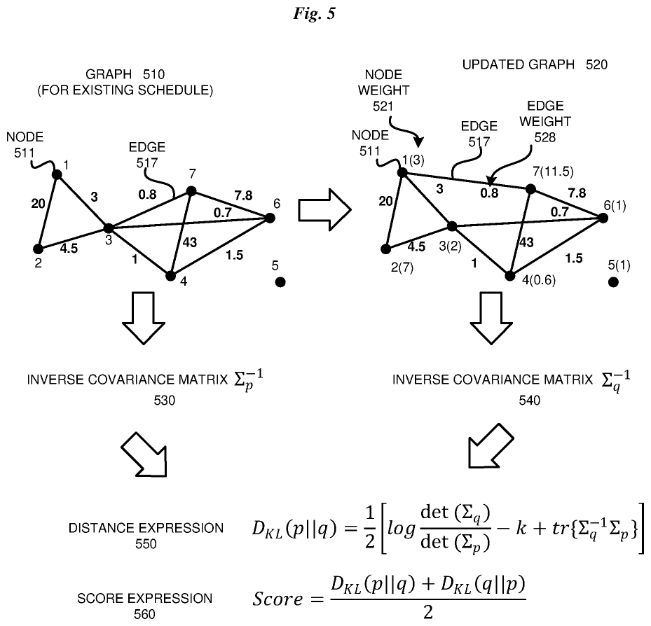

With reference to FIG. 5, this figure depicts an example of graph divergence scoring for use in automated fleet asset health monitoring and maintenance scheduling in accordance with an illustrative embodiment.

Graph 510 depicts a graph representing a previous state of a set of assets being managed as a fleet, that was used to generate an existing maintenance schedule. Each node of graph 510 (e.g., node 511) represents an asset, or a group of assets being managed as a single asset. Each edge of graph 510 (e.g., edge 517), connecting two nodes, represents a connection, or relationship, between two assets, each represented by one of the nodes. Both nodes and edges of graph 510 are weighted. Weights of the edges of graph 510 are indicated by numbers next to the edges. Weights of the nodes of graph 510 are not depicted.

Updated graph 520 depicts a graph representing a current state of a set of assets being managed as a fleet, for use in determining whether to adjust an existing maintenance schedule. Each node of graph 520 (e.g., node 511) represents an asset, or a group of assets being managed as a single asset. Each edge of graph 520 (e.g., edge 517), connecting two nodes, represents a connection, or relationship, between two assets, each represented by one of the nodes. Note that edge 517 in graph 520 connects different nodes from edge 517 in graph 510. Both nodes and edges of graph 520 are weighted, e.g., node weight 521 and edge weight 528.

Application 200 represents graph 510 as inverse covariance matrix Σₚ⁻¹ 530, in which weights of nodes in graph 510 are the diagonal entries in the matrix, and weights of edges in graph 510 are the non-diagonal entries in the matrix. Application 200 represents graph 520 as inverse covariance matrix Σ_{q}⁻¹ 540, in which weights of nodes in graph 520 are the diagonal entries in the matrix, and weights of edges in graph 520 are the non-diagonal entries in the matrix.

Application 200 uses matrices 530 and 540 to compute a distance score between graphs 510 and 520 using distance expression 550 and score expression 560. In distance expression 550, k denotes the number of nodes in the graphs p and q and the tr{ } operation sums the diagonals of the elements in a matrix. Score expression 560 is the average of distance expression 550 and another version of distance expression 550 calculated by replacing Σ_{q} with Σₚ and vice versa.

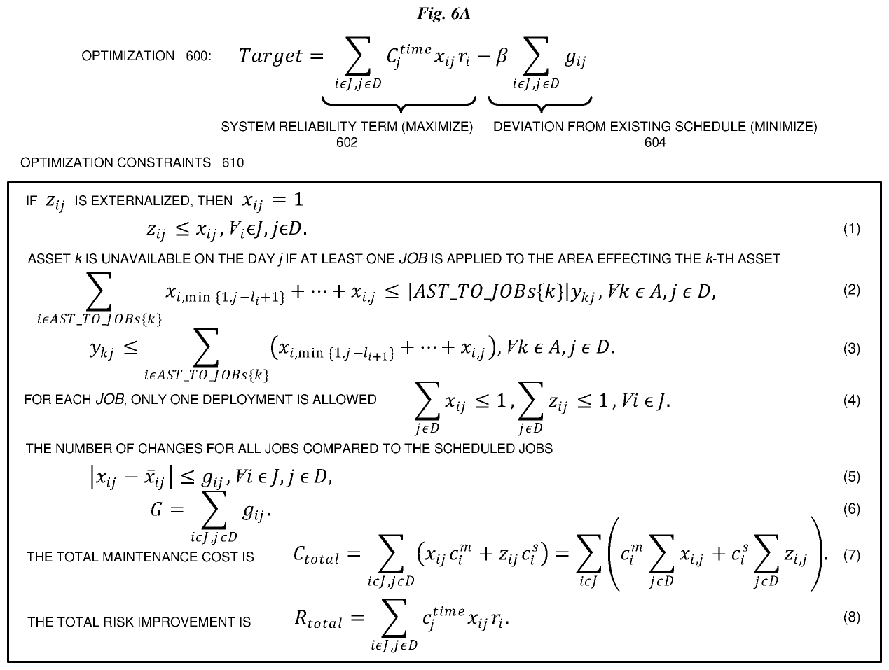

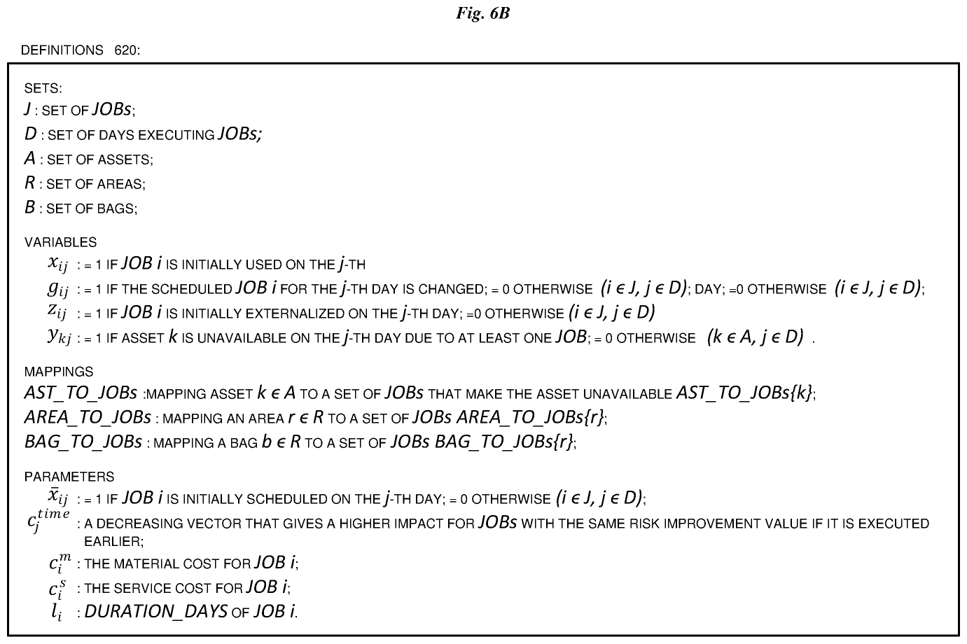

With reference to FIGS. 6A and 6B, these figures depict an optimization problem for use in automated fleet asset health monitoring and maintenance scheduling in accordance with an illustrative embodiment. In particular, FIG. 6A depicts the optimization problem and constraints, and FIG. 6B provides definitions for the optimization problem.

As depicted in FIG. 6A, application 200 defines the target of optimization 600 as maximizing system reliability term 602, thus improving a risk of the set of assets, while minimizing deviation from the current maintenance schedule 604, using optimization constraints 610. The terms in system reliability term 602, deviation from the current maintenance schedule 604, and optimization constraints 610 are defined in definitions 620 in FIG. 6B. In definitions 620, a job represents a maintenance task in the maintenance schedule, an area represents a region in which a job is performed, and a bag represents a collection of jobs grouped together when assigning them to a technician. In another implementation of application 200, optimization constraints 610 are adjusted to account for days on which some jobs cannot be executed (e.g., holidays and weekends), to add a constraint that no more than 1 asset of a particular type is unavailable at the same time unless they come from the same job, and to attempt to minimize the number of times an asset becomes unavailable.

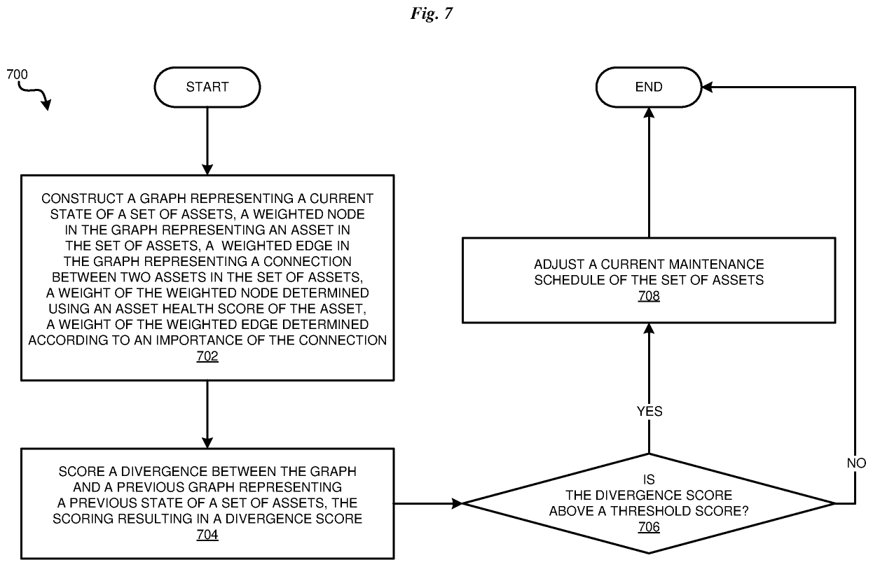

With reference to FIG. 7, this figure depicts a flowchart of an example process for automated fleet asset health monitoring and maintenance scheduling in accordance with an illustrative embodiment. Process 700 can be implemented in application 200 in FIG. 2.

In block 702, the application constructs a graph representing a current state of a set of assets, a weighted node in the graph representing an asset in the set of assets, a weighted edge in the graph representing a connection between two assets in the set of assets, a weight of the weighted node determined using an asset health score of the asset, a weight of the weighted edge determined according to an importance of the connection. In block 704, the application scores a divergence between the graph and a previous graph representing a previous state of a set of assets, the scoring resulting in a divergence score. In block 706, the application determines whether the divergence score is above a threshold score. If yes (“YES” path of block 706), in block 708, the application adjusts a current maintenance schedule of the set of assets. Then (also “NO” path of block 706), the application ends.

Thus, a computer implemented method, system or apparatus, and computer program product are provided in the illustrative embodiments for automated fleet asset health monitoring and maintenance scheduling and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
constructing a graph representing a current state of a set of assets, a weighted node in the graph representing an asset in the set of assets, a weighted edge in the graph representing a connection between two assets in the set of assets, a weight of the weighted node determined using an asset health score of the asset, a weight of the weighted edge determined according to an importance of the connection;
scoring a divergence between the graph and a previous graph representing a previous state of the set of assets, the scoring resulting in a divergence score; and
adjusting, responsive to the divergence score being above a threshold score, a current maintenance schedule of the set of assets, the adjusting resulting in an adjusted maintenance schedule.

2. The computer-implemented method of claim 1, wherein the asset health score of the asset is determined by evaluating, by analyzing condition data of the asset, a health condition of the asset.

3. The computer-implemented method of claim 1, wherein scoring the divergence between the graph and the previous graph comprises calculating a divergence between inverse covariance matrices corresponding to the graph and the previous graph.

4. The computer-implemented method of claim 3, wherein the divergence comprises an average of a Kullback-Leibler divergence from the inverse covariance matrix corresponding to the graph to the inverse covariance matrix corresponding to the previous graph and a Kullback-Leibler divergence from the inverse covariance matrix corresponding to the previous graph to the inverse covariance matrix corresponding to the graph.

5. The computer-implemented method of claim 1, further comprising:
constructing a differences graph, a weighted node in the difference graph representing an asset in the set of assets, a weight of a weighted edge in the differences graph comprising a difference between corresponding elements of inverse covariance matrices corresponding to the graph and the previous graph;
identifying, using a subgraph of the difference graph comprising a highest average weight in the set of edge weights in the subgraph, a portion of the set of assets requiring an adjustment to the current maintenance schedule, the portion of the set of assets corresponding to nodes in the subgraph.

6. The computer-implemented method of claim 1, wherein adjusting the maintenance schedule of the set of assets is performed by solving an optimization problem, a target of the optimization problem comprising maximizing risk improvement of the set of assets while minimizing deviation from the current maintenance schedule of the set of assets.

7. The computer-implemented method of claim 1, further comprising:
causing performance of the adjusted maintenance schedule, the performance resulting in an alteration in an asset health score of an asset in the set of assets.

8. A computer program product comprising one or more computer readable storage medium, and program instructions collectively stored on the one or more computer readable storage medium, the program instructions executable by a processor to cause the processor to perform operations comprising:
constructing a graph representing a current state of a set of assets, a weighted node in the graph representing an asset in the set of assets, a weighted edge in the graph representing a connection between two assets in the set of assets, a weight of the weighted node determined using an asset health score of the asset, a weight of the weighted edge determined according to an importance of the connection;
scoring a divergence between the graph and a previous graph representing a previous state of the set of assets, the scoring resulting in a divergence score; and
adjusting, responsive to the divergence score being above a threshold score, a current maintenance schedule of the set of assets, the adjusting resulting in an adjusted maintenance schedule.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the asset health score of the asset is determined by evaluating, by analyzing condition data of the asset, a health condition of the asset.

12. The computer program product of claim 8, wherein scoring the divergence between the graph and the previous graph comprises calculating a divergence between inverse covariance matrices corresponding to the graph and the previous graph.

13. The computer program product of claim 12, wherein the divergence comprises an average of a Kullback-Leibler divergence from the inverse covariance matrix corresponding to the graph to the inverse covariance matrix corresponding to the previous graph and a Kullback-Leibler divergence from the inverse covariance matrix corresponding to the previous graph to the inverse covariance matrix corresponding to the graph.

14. The computer program product of claim 8, further comprising:
constructing a differences graph, a weighted node in the difference graph representing an asset in the set of assets, a weight of a weighted edge in the differences graph comprising a difference between corresponding elements of inverse covariance matrices corresponding to the graph and the previous graph;
identifying, using a subgraph of the difference graph comprising a highest average weight in the set of edge weights in the subgraph, a portion of the set of assets requiring an adjustment to the current maintenance schedule, the portion of the set of assets corresponding to nodes in the subgraph.

15. The computer program product of claim 8, wherein adjusting the maintenance schedule of the set of assets is performed by solving an optimization problem, a target of the optimization problem comprising maximizing risk improvement of the set of assets while minimizing deviation from the current maintenance schedule of the set of assets.

16. The computer program product of claim 8, further comprising:
causing performance of the adjusted maintenance schedule, the performance resulting in an alteration in an asset health score of an asset in the set of assets.

17. A computer system comprising a processor and one or more computer readable storage media, and program instructions collectively stored on the one or more computer readable storage media, the program instructions executable by the processor to cause the processor to perform operations comprising:
constructing a graph representing a current state of a set of assets, a weighted node in the graph representing an asset in the set of assets, a weighted edge in the graph representing a connection between two assets in the set of assets, a weight of the weighted node determined using an asset health score of the asset, a weight of the weighted edge determined according to an importance of the connection;
scoring a divergence between the graph and a previous graph representing a previous state of the set of assets, the scoring resulting in a divergence score; and
adjusting, responsive to the divergence score being above a threshold score, a current maintenance schedule of the set of assets, the adjusting resulting in an adjusted maintenance schedule.

18. The computer system of claim 17, wherein the asset health score of the asset is determined by evaluating, by analyzing condition data of the asset, a health condition of the asset.

19. The computer system of claim 17, wherein scoring the divergence between the graph and the previous graph comprises calculating a divergence between inverse covariance matrices corresponding to the graph and the previous graph.

20. The computer system of claim 19, wherein the divergence comprises an average of a Kullback-Leibler divergence from the inverse covariance matrix corresponding to the graph to the inverse covariance matrix corresponding to the previous graph and a Kullback-Leibler divergence from the inverse covariance matrix corresponding to the previous graph to the inverse covariance matrix corresponding to the graph.
